(19) United States
(12) Patent Application Publication
(10) Pub. No.: US 2005/0029063 A1
(43) Pub. Date: Feb. 10, 2005

(54) Shock absorber having variable damping characteristics and method of damping vibrations with the shock absorber

(75) Inventor: Helmut Neumann, Glinde (DE)

Correspondence Address: GREENBLUM & BERNSTEIN, P.L.C., 1950 ROLAND CLARKE PLACE, RESTON, VA, 20191, US

(73) Assignee: BALTIC ELECTRONIK GmbH, Hamburg (DE)

(21) Appl. No.: 10/896,892

(22) Filed: Jul. 23, 2004

(30) Foreign Application Priority Data
Jul. 24, 2003 (EP) 03090230.8

(51) Int. Cl. F16F 9/34

(52) U.S. Cl. 188/322.13; 188/317

(57) ABSTRACT

Shock absorber having variable damping characteristics. The shock absorber includes a shock absorber cylinder containing a damping medium. A piston rod extends into the shock absorber cylinder. A piston is arranged on a free end of the piston rod. The piston is structured and arranged to divide a space inside the shock absorber cylinder into two chambers. The two chambers are in fluid communication with each other via a main flow channel and a plurality of secondary flow channels. A valve device is structured and arranged to open and close the secondary flow channels. The valve device comprises a plurality of separately controllable spool valves movably arranged on a base member and a plurality of valve members having different flow characteristics. One of the valve members is assigned to one of the secondary flow channels and another of the valve members is assigned to another of the secondary flow channels. This Abstract is not intended to define the invention disclosed in the specification, nor intended to limit the scope of the invention in any way.

### CROSS-REFERENCE TO RELATED APPLICATIONS

The present application claims priority under 35 U.S.C. § 119 of European Patent Application No. 03090230.8, filed on Jul. 24, 2003, the disclosure of which is expressly incorporated by reference herein in its entirety.

### BACKGROUND OF THE INVENTION

1. Field of the Invention

The invention relates to a shock absorber having variable damping characteristic, in particular for motor vehicles. The device substantially comprises a shock absorber cylinder filled with a damping medium. A piston rod is sealed off and dips and/or extends into the shock absorber cylinder. A piston is arranged on a free end of the piston rod in such a way that the piston is sealed off with respect to the shock absorber cylinder. The piston divides the space inside the shock absorber cylinder into two chambers. The chambers are joined to and/or communicate with one another via a main flow channel and a plurality of secondary flow channels. A valve device for opening and closing the secondary flow channels is utilized. The valve device possesses a plurality of separately controllable spool valves which are displaceable and/or movably arranged on a base structure and a plurality of valve members having different flow characteristics.

2. Discussion of Background Information

Known shock absorbers of the type having variable damping characteristic possess a valve device having two switchable secondary flow channels. Two valve members are arranged inside the secondary flow channels. A first valve member with a valve body is assigned directly to a first secondary flow channel. The second valve member, likewise composed of a valve body, is arranged centrally. Thereby, the second valve member is assigned to both the first secondary flow channel and the second secondary flow channel. This means that the damping medium, in the event that the spool valve is open and it flows through the second secondary flow channel, need overcome one single valve member, namely the centrally located valve member assigned to both secondary flow channels jointly. If, on the other hand, with correspondingly open spool valve the damping medium flows through the first secondary flow channel it has to overcome two valve members, namely the directly assigned first valve member, on the one hand, and the second central valve member, on the other hand. In other words, the known shock absorber has three different damping positions, whereby the damping characteristics of the secondary flow channels depend on one another on account of the common valve member.

In a first damping position, both secondary flow channels are closed by the spool valves, so that the damping medium has to flow through the main flow channel. The damping characteristic of the main flow channel, however, is usually very hard. If the first secondary flow channel is in the open position, the two valve members, which are arranged in series in the first secondary flow channel and overall have a lower resistance, that is a softer flow characteristic, relative to the main flow channel, ensure a softer damping characteristic. In the event that the second secondary flow channel is in the open position, the damping medium chooses the path of least resistance through the valve member of the second secondary flow channel, since inside the second secondary flow channel only one valve member, namely the central valve member, has to be overcome.

This has the disadvantage that fine and comfortable adjustment of the damping characteristic is difficult, since the damping characteristic of one secondary flow channel depends on the damping characteristic of the other secondary flow channel. Furthermore, the setting possibilities of the valve device are also overall limited. In particular, compensation for fine degrees of unevenness, for example on a roadway, i.e. a particularly soft damping characteristic, is not possible due to the partially common arrangement of the valve members inside the secondary flow channels, since the damping medium at least in one secondary flow channel always has to overcome two valve members in order to move from one chamber to the other or vice versa.

### SUMMARY OF THE INVENTION

Accordingly, the invention proposes a compact shock absorber which has an improved and optimally adjustable damping characteristic, and hence, in particular, increases driving comfort, e.g. in a motor vehicle.

The invention also provides for a shock absorber of the above mentioned type wherein a separate valve member is assigned to each secondary flow channel. By way of this construction according to the invention, driving comfort is increased by improved adjustability of the damping characteristic, since on flowing through the secondary flow channels the damping medium need in each case overcome only a single valve member, each of which is fully adjustable independent of one another. Due to the fact that precisely one valve member is assigned to each secondary flow channel, and thus each of the valve members is located inside the assigned secondary flow channel, adjustability is made more precise. In other words, by dispensing with a central valve member for both secondary flow channels, the adjustability of the damping characteristic of the shock absorber is improved.

In a particularly preferred embodiment of the invention, in addition to the two secondary flow channels another additional secondary flow channel is provided inside the valve device. By increasing the number of so-called bypasses each of which has a completely independent damping characteristic, the range of adjustable damping characteristics also simultaneously increases so that comfort is further increased. Making use of the additional secondary flow channel a total of four different damping characteristics can be set. The third secondary flow channel within the valve device ensures increased comfort without changing the overall size of the valve device, so that the shock absorbers possess more possibilities of adjustment while the overall size remains the same.

Advantageously, the additional secondary flow channel is free of valve members. By way of this embodiment a particularly soft and hence comfortable damping characteristic is achieved, so that the shock absorber itself can respond to the smallest degrees of unevenness.

In a preferred variant of the invention the third secondary flow channel is constructed in such a way that, in the open position of the spool valves of the other two secondary flow channels, it is open. This has the effect that increasing the number of setting possibilities is achievable without enlarging the structural shape of the valve device and hence that of the shock absorber, since additional spool valves for opening and closing the additional secondary flow channel can be dispensed with.

The invention also provides for a shock absorber having variable damping characteristics, wherein the shock absorber comprises a shock absorber cylinder containing a damping medium. A piston rod extends into the shock absorber cylinder. A piston is arranged on a free end of the piston rod. The piston is structured and arranged to divide a space inside the shock absorber cylinder into two chambers. The two chambers are in fluid communication with each other via a main flow channel and a plurality of secondary flow channels. A valve device is structured and arranged to open and close the secondary flow channels. The valve device comprises a plurality of separately controllable spool valves movably arranged on a base member and a plurality of valve members having different flow characteristics. One of the valve members is assigned to one of the secondary flow channels and another of the valve members is assigned to another of the secondary flow channels.

The shock absorber may be structured and arranged for use on a motor vehicle. The piston may be in sealing engagement with the shock absorber cylinder. The one of the valve members may be arranged to at least one of block and allow flow through one of the secondary flow channels and the other of the valve members is arranged to at least one of block and allow flow through another of the secondary flow channels. The one of the valve members may be spaced apart from the other of the valve members. The one of the valve members and the other of the valve members may comprise separate valve members.

The one of the valve members may be structured and arranged to allow fluid flow through at least one of the secondary flow channels and between the two chambers, and the other of the valve members may be structured and arranged to prevent fluid flow through at least another of the secondary flow channels and between the two chambers.

The one of the valve members may be structured and arranged to prevent fluid flow through at least one of the secondary flow channels and between the two chambers, and the other of the valve members may be structured and arranged to allow fluid flow through at least another of the secondary flow channels and between the two chambers.

Each of the valve members may comprise a single valve body. At least one of the valve members may be an excess-pressure valve. Each of the valve members may be an excess-pressure valve. At least one of the valve members may be arranged within the main flow channel. At least one of the valve members may be arranged within the main flow channel, the one of the valve members may be arranged within one of the secondary flow channels, and the other of the valve members may be arranged within another of the secondary flow channels. Each of the valve members may have a different flow characteristic.

The plurality of secondary flow channels may comprise two secondary flow channels. The plurality of secondary flow channels may comprise first, second and third secondary flow channels. The third secondary flow channel may be arranged within the valve device. The third secondary flow channel may be structured and arranged to allow fluid flow therethrough when the first and second flow channels allow fluid flow therethrough. The third secondary flow channel may be structured and arranged to allow fluid flow therethrough when the spool valves are in an open position.

One of the spool valves may comprise an inner recess and the base member may comprise at least one recess. The one of the spool valves may be movable between at least a first position, wherein the inner recess and the at least one recess of the base member are in fluid communication with each other, and a second position, wherein the inner recess and the at least one recess of the base member are not in fluid communication with each other. The inner recess may comprise an inner circumferential recess. The valve device may further comprise a through-opening structured and arranged to provide fluid communication between one of the two chambers and the inner circumferential recess.

The valve device may further comprise a through-opening structured and arranged to provide fluid communication between one of the two chambers and an inner circumferential recess of one of the spool valves. At least one of the secondary flow channels may be free of valve members. The plurality of secondary flow channels may comprise first, second and third secondary flow channels and the plurality of the valve members may comprise first, second, and third valve members.

The invention also provides for a method of damping vibrations using the shock absorber described above, wherein the method comprises allowing, at least during an expansion phase of the shock absorber, fluid to flow through the main flow channel when the spool valves are closed, allowing, at least during an expansion phase of the shock absorber, fluid to flow through at least one of the secondary flow channels when one of the spool valves are opened and another of the spool valves are closed, and allowing, at least during an expansion phase of the shock absorber, fluid to flow through another of the secondary flow channels when another of the spool valves are opened and the one of the spool valves is closed.

The invention also provides for a shock absorber having variable damping characteristics, wherein the shock absorber comprises a shock absorber cylinder containing a damping medium. A piston rod is movably arranged within the shock absorber cylinder. A piston coupled to the piston rod. The piston is structured and arranged to divide a space inside the shock absorber cylinder into first and second chambers. The first and second chambers are in fluid communication with each other via a main flow path and at least first and second secondary flow paths. A valve device is arranged between the piston and the piston rod. The valve device comprises first and second separately controllable spool valves movably arranged on a base member and at least first and second valve members having different flow characteristics. The first valve member is structured and arranged to allow and prevent fluid flow through the first secondary flow path. The second valve member is structured and arranged to allow and prevent fluid flow through the second secondary flow path.

The shock absorber may be structured and arranged for use on a motor vehicle. The piston may be in sealing engagement with the shock absorber cylinder. The valve device may comprise a position wherein the first valve member allows fluid flow through the first secondary flow path and between the first and second chambers, and the second valve member prevents fluid flow through the second secondary flow path and between the first and second chambers. The valve device may comprise another position wherein the second valve member allows fluid flow through the second secondary flow path and between the first and second chambers, and the first valve member prevents fluid flow through the first secondary flow path and between the first and second chambers.

Each of the first and second valve members may comprise a single valve body. At least one of the first and second valve members may be an excess-pressure valve.

The shock absorber may further comprise a third valve member structured and arranged to allow and prevent fluid flow through the main flow path. Each of the first, second and third valve members may have different flow characteristics.

The shock absorber may further comprise a third secondary flow path allowing fluid communication between the first and second chambers via the valve device. The third secondary flow path may be structured and arranged to allow fluid flow therethrough when the first and second flow paths allow fluid flow therethrough. The third secondary flow path may be structured and arranged to allow fluid flow therethrough when the first and second spool valves are in an open position. The first spool valve may comprise an inner recess and wherein the base member comprises at least one recess. The first spool valve may be movable between at least a first position, wherein the inner recess and the at least one recess of the base member are in fluid communication with each other, and a second position, wherein the inner recess and the at least one recess of the base member are not in fluid communication with each other. The inner recess may comprise an inner circumferential recess. The valve device may further comprise a through-opening structured and arranged to provide fluid communication between one of the two chambers and the inner circumferential recess.

The valve device may further comprise a through-opening structured and arranged to provide fluid communication between the one of the first and second chambers and an inner circumferential recess of one of the first and second spool valves.

The shock absorber may further comprise a third secondary flow path which is free of valve members.

The shock absorber may further comprise a third secondary flow path and a third valve member.

The invention also provides for a method of damping vibrations using the shock absorber of described above, wherein the method comprises allowing, at least during an expansion phase of the shock absorber, fluid to flow through the main flow path when the first and second spool valves are closed, allowing, at least during an expansion phase of the shock absorber, fluid to flow through the first secondary flow path when the first spool valve is opened and the second spool valve is closed, and allowing, at least during an expansion phase of the shock absorber, fluid to flow through the second secondary flow path when the second spool valve is opened and the first spool valve is closed.

The invention also provides for a shock absorber having variable damping characteristics, wherein the shock absorber comprises a shock absorber cylinder containing a damping medium. A piston rod is movably arranged within the shock absorber cylinder. A piston is coupled to the piston rod and is in sealing engagement with the shock absorber cylinder. The piston is structured and arranged to divide a space inside the shock absorber cylinder into first and second chambers. The first and second chambers-are in fluid communication with each other via a main flow path and at least first and second secondary flow paths. The main flow path passes through an opening in the piston, wherein the opening is offset from a center axis of the piston rod. The first and second flow paths pass through a different opening extending through the piston. A valve device has a larger diameter tubular end coupled to the piston and a smaller diameter end coupled to the piston rod. The valve device comprises first and second separately controllable spool valves movably arranged on a base member and at least first and second valve members having different flow characteristics. A first spring biases the first spool valve towards a closed position and a second spring biases the second spool valve towards a closed position. The first valve member is structured and arranged to allow and prevent fluid flow through the first secondary flow path. The second valve member is structured and arranged to allow and prevent fluid flow through the second secondary flow path.

The valve device has one end which is connected to the piston and another end which is threadably connected to the piston rod.

### BRIEF DESCRIPTION OF THE DRAWINGS

The present invention is further described in the detailed description which follows, in reference to the noted plurality of drawings by way of non-limiting exemplary embodiments of the present invention, in which like reference numerals represent similar parts throughout the several views of the drawings, and wherein:

FIG. 1 shows a shock absorber having an open first secondary flow channel and a closed second secondary flow channel in cross-section;

FIG. 2 shows the shock absorber according to FIG. 1 illustrating flow of the damping medium through the main flow channel during actuation of the tensile step and/or expansion phase. The spool valves of the secondary flow channels are closed;

FIG. 3 shows the shock absorber according to FIG. 1 illustrating flow of the damping medium through the first secondary flow channel during actuation of the tensile step and/or expansion phase. The spool valve of the second secondary flow channel is closed;

FIG. 4 shows the shock absorber according to FIG. 1 illustrating flow of the damping medium through the second secondary flow channel during actuation of the tensile step and/or expansion phase;

FIG. 5 shows the shock absorber according to FIG. 1 illustrating flow of the damping medium through the third secondary flow channel during actuation of the tensile step and/or expansion phase. The spool valves of the first and second secondary valves are open; and

FIG. 6 shows the shock absorber according to FIG. 3 in two positions of action, namely during actuation of the tensile step and/or expansion phase, and during actuation of the compressive phase.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The invention relates, by way of non-limiting example, to shock absorbers having variable damping characteristic which are employed in particular in the motor vehicle sector.

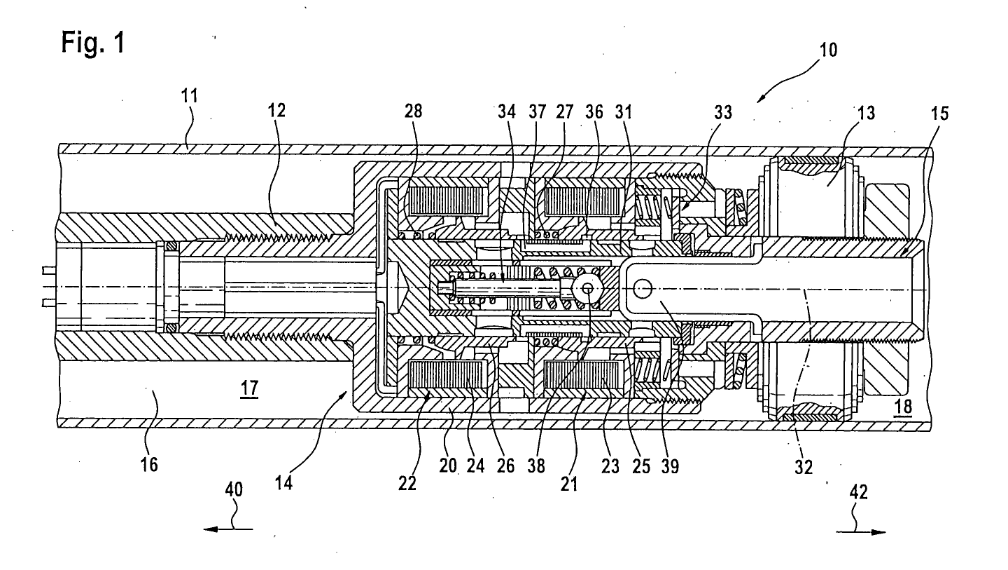

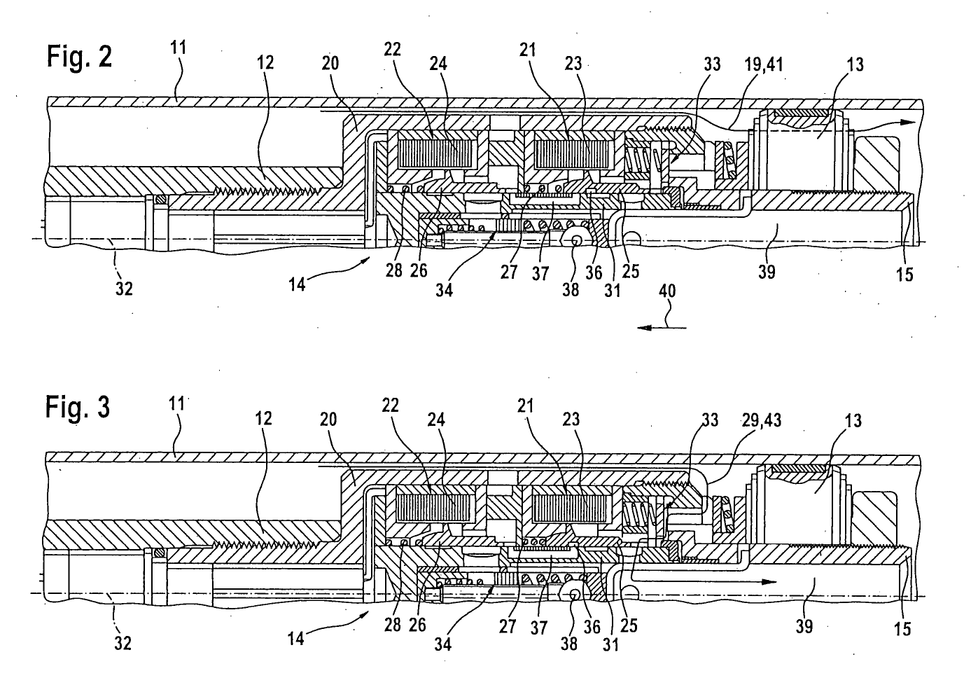

FIG. 1 shows a portion of a shock absorber 10. The shock absorber 10 substantially includes a shock absorber cylinder 11, a piston rod 12, a piston 13, and a valve device 14. The piston rod 12 is sealed off in known manner and dips or extends into the shock absorber cylinder 11 in such a way that a damping medium, e.g., oil, gas or other fluid, located inside the shock absorber cylinder 11 cannot escape from the shock absorber cylinder 11. In the region of a free end 15 of the piston rod 12, the piston 13 is arranged on the rod 12 and is sealed off with respect to the shock absorber cylinder 11 in customary manner, e.g., by a ring seal. The piston 13 divides the interior 16 of the shock absorber 10 into two chambers 17, 18. The two chambers 17, 18 are joined to one another by a main flow channel 19 (see FIG. 2) which is described later in more detail. The main flow channel 19 may also be formed of a plurality of individual channels. Associated with the main flow channel 19 (appropriately in the region of the piston 13) are valve members (not illustrated), e.g., spring washers, which, through their flow characteristic, determine the damping characteristic of the main flow channel 19. The flow characteristic is the designation for the force/resistance at which the valve members open against an elastic force or the like. If, however, valve members having a hard flow characteristic are utilized, a great force or a great pressure may be needed to open them. Valve members having a soft flow characteristic already open at low pressure. The valve device 14 is likewise detachably fastened and/or removably connected to the piston rod 12 and serves to control or set the damping characteristic(s) of the shock absorber 10.

The valve device 14 has a valve housing 20 in which a plurality of control elements are arranged. The control elements include, in customary manner, electromagnets 21, 22 which are fitted with corresponding exciting coils 23, 24. Other known control elements may also be used. Actively connected to each of the electromagnets 21, 22 (or the exciting coils 23, 24) are spool valves 25, 26. The spool valves 25, 26 can be moved from a closed position (wherein the secondary flow channels 29, 30 are closed) to an open position (in which the secondary flow channels 29, 30 are open) against the biasing action of spring elements 27, 28. For this purpose, the annular spool valves 25, 26 are movably arranged and/or mounted on a base member 31 and move preferably in the longitudinal direction of the piston rod 12 and parallel to a center axis 32 of the piston rod 12.

Assigned to each secondary flow channel 29, 30, is a separate valve member 33, 34. These valve members 33, 34 function completely independent of each other. In the embodiment shown, each valve member 33, 34 possesses a single valve body. However, the invention also contemplates that one or more of the valve members 33, 34 utilize a plurality of valve bodies. In this case, it is preferred that the plurality of valve bodies be connected in series. The valve members 33, 34 each possess a reciprocally spring-loaded valve body which is subject to pressure and are adjustably constructed as excess pressure valves. They also differ individually in their respective flow characteristic. Both flow characteristics also differ from the flow characteristic of the main flow channel 19 so that, due to this construction, a total of three different damping characteristics are formed and/or provided within the shock absorber 10.

Another secondary flow channel 35 can also be provided. In order to form at least one other secondary flow channel 35, which ensures at least one other, fourth damping characteristic, and hence a further increase in comfort by comparison with known shock absorbers, one of the spool valves, preferably the spool valve 25, can be provided with an all-round annular recess 36. This recess 36 can be brought into functional connection with a channel-like recess 37 in the base member 31. The recesses 36 and 37 can then communicate with each other when the spool valves 25, 26 of the secondary flow channels 29, 30 are each in their open position. To connect the chamber 17 to the chamber 18 (i.e., provide fluid communication between chambers 17 and 18) a through-hole 38 is arranged on the valve device 14. The hole 38 extends radially, namely perpendicularly to the central axis 32, from the recess 36 inwardly into a hollow section 39 of the piston rod 12. The hollow section 39 opens out into the chamber 18.

In the embodiment shown in the figures, the third secondary flow channel 35 has no valve members, so that, in the correspondingly connected state (described below in more detail), the damping medium can flow unimpeded from the chamber 17 into the chamber 18, and vice versa. In an alternative embodiment (not shown), another valve member can be arranged inside the third secondary flow channel 35, whereby the other valve member has a flow characteristic which differs from the flow characteristics of the valve members 33, 34 of the secondary flow channels 29, 30, and from the flow characteristic of the valve member of the main flow channel 19. Due to this construction, a total of four different damping characteristics can be formed and/or provided within the shock absorber 10.

The shock absorber 10 or the valve device 14 is connected to a central control device (not shown). In this way, each desired damping characteristic can be made adjustable and controllable. Altogether, four different damping characteristics can be set, whereby the damping hardness diminishes from the damping characteristic of the main flow channel 19 down to the damping characteristic of the third secondary flow channel 35. In other words, damping is hardest when the damping medium flows through the main flow channel 19 and softest when it flows through the secondary flow channel 35.

In conventional shock absorbers, without the described valve device 14, on actuation of the tensile step (expansion phase) or compressive step (compressive phase), the damping medium must necessarily flow through the main flow channel 19 from one chamber 17 into the other chamber 18 or vice versa. In order, however, to be able to influence the damping characteristic, the secondary flow channels 29, 30 and 35 are provided. These secondary flow channels 29, 30 and 35 are also referred to as bypasses. The damping medium always chooses the path of least resistance to move from the chamber 17 into the chamber 18 (on actuation of the tensile step) or from the chamber 18 into the chamber 17 (on actuation of the compressive step). For better understanding of the invention the individual states are explained in more detail with reference to FIGS. 2 to 5, whereby FIGS. 2 to 5 each show only a half of a portion of the shock absorber 10. Since, in any case, the shock absorber 10 is of rotationally symmetrical construction relative to the central axis 32 a full illustration can be dispensed with in detail.

In FIG. 2, the valve device 14 is connected in such a way that both spool valves 25, 26 are in the closed position, and hence seal the secondary flow channels 29, 30, 35. Accordingly, the damping medium is forced to flow through the piston 13, for example, by way of elastic valve washers or the like (not shown), via the main flow channel 19 from the chamber 17 into the chamber 18. In the embodiment shown in FIG. 2, actuation of the tensile step (expansion phase) is illustrated. This means that under tensile load (movement of the piston rod 12 in the direction of the arrow 40) the shock absorber 10 is extended. This is also referred to as rebounding. The elastic valve washers are constructed in such a way that their flow characteristic is at variance with that of the valve members 33, 34 and is appropriately harder. Since the spool valves 25, 26 are in the closed position, however, the damping medium flows through the main flow channel 19 in the direction of the arrow 41. In the indexing position illustrated in FIG. 2, the shock absorber 10 exhibits its hardest damping. In the event of actuation of the compressive step, that is a compressive load acting on the shock absorber 10 (movement of the piston rod 12 in the direction of the arrow 42), referred to as flexing, the damping medium flows on the same path counter to the direction of the arrow 41.

To change the damping, preferably to “soften” the damping, at least a portion of the damping medium, but preferably all of the damping medium, has to be led through a “softer” secondary flow channel. For this purpose, in the indexing position shown in FIG. 3, the first secondary flow channel 29 is opened. This means that by excitation by way of the exciting coil 23, the spool valve 25 stands in an open position against the biasing and/or expansion force of the spring element 27. The spool valve 26 continues in its closed position. On a tensile movement of the shock absorber 10 (in the direction of the arrow 40), the damping medium flows in the direction of the arrow 43 through the first secondary flow channel 29. In doing so, the damping medium causes the valve member 33 with a softer setting (that is has a softer flow characteristic than the valve washers of the main flow channel 19) to open. On a compressive movement of the shock absorber 10) the damping medium flows in the opposite direction. By de-excitation of the exciting coil 23, the spool valve 25 is moved into its closed position by way of the biasing force of the spring element 27.

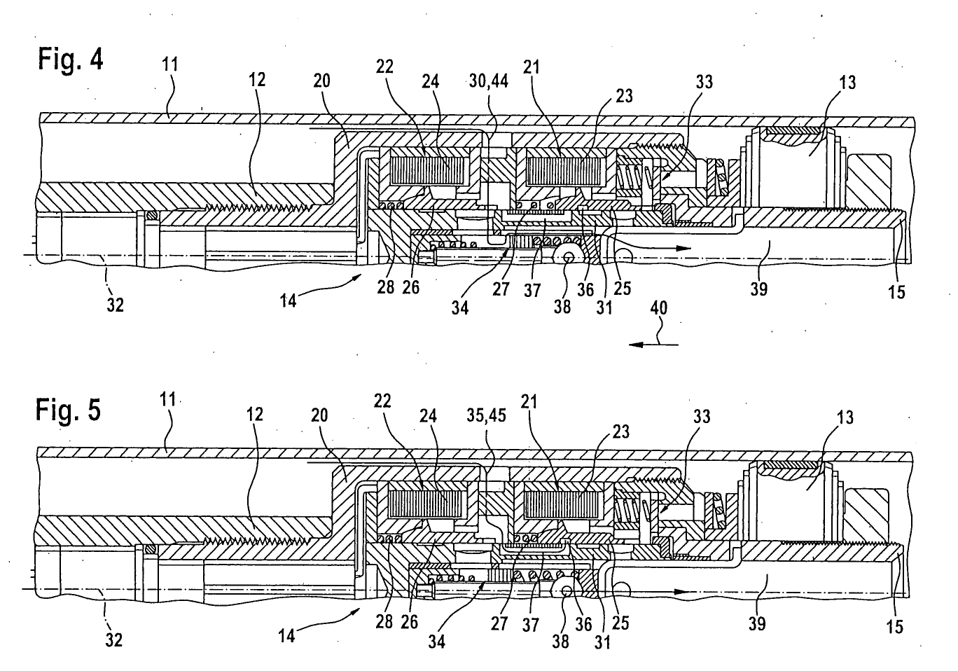

FIG. 4 shows the shock absorber 10 with the secondary flow channel 30 open. For this purpose, the spool valve 26 is in its open position against the biasing force of the spring element 28 due to excitation of the exciting coil 24. The spool valve 25 is in its closed position, whereby positioning of the spool valve 25 in the open position is also possible, provided the flow characteristic of the valve member 34 is softer than the flow characteristic of the valve member 33. Accordingly, the path of least resistance for the damping medium inevitably takes it through the secondary flow channel 30, so that on actuation of the tensile step, the damping medium follows the arrow 44. On actuation of the compressive step, the damping medium flows in the direction opposite to the arrow 44.

In the indexing position according to FIG. 5, both spool valves 25, 26 are in their open position. As a result, in both secondary flow channels 29, 30, the only impediment to the damping medium is the valve members 33, 34. Due to the positions of the spool valves 25, 26, the third secondary flow channel 35 is open but free of valve members. Thus, for soft damping, the damping medium flows in the direction of the arrow 45 through the third secondary flow channel 35. In the event that a valve member is arranged in the third secondary flow channel 35, the flow characteristic of the valve member would have a softer pattern by comparison with the valve members of the main flow channel 19 and of the secondary flow channels 29, 30. In other words, to overcome the valve member in the secondary flow channel 35, a lower pressure relative to the valve members 33, 34 is necessary, so that the damping medium would flow through the third secondary flow channel 35. The damping medium would flow through the third secondary flow channel 35 and the through-hole 38 from the chamber 17 into the chamber 18 or vice versa.

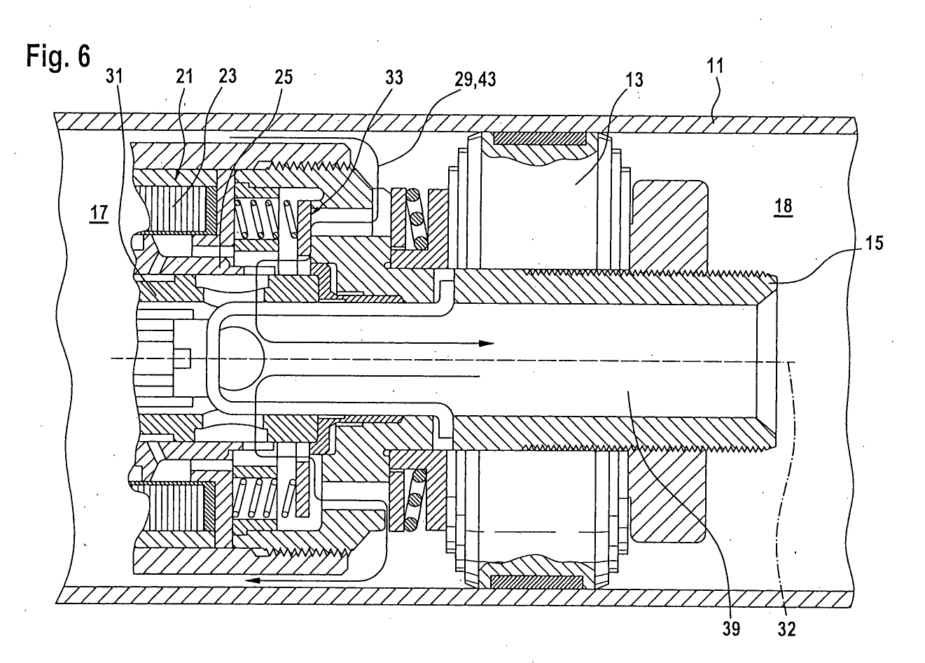

To illustrate the operational principle of the shock absorber 10 according to the invention, FIG. 6 shows different operating positions, that is, actuation of the tensile step, on the one hand, and actuation of the compressive step, on the other hand, from which the flow of the damping medium, when the secondary flow channel 29, is open emerges.

The valve device 14 described in detail can be employed universally in different types of vibration dampers, e.g., single-cylinder or double-cylinder shock absorbers, and in particular also retrofitted by simple arrangements in existing shock absorbers. The principle of the third secondary flow channel 35 can also be integrated in valve devices 14 possessing more than two spool valves 25, 26.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

1. A shock absorber having variable damping characteristics, the shock absorber comprising:
a shock absorber cylinder containing a damping medium;
a piston rod extending into the shock absorber cylinder;
a piston arranged on a free end of the piston rod;
the piston being structured and arranged to divide a space inside the shock absorber cylinder into two chambers;
the two chambers being in fluid communication with each other via a main flow channel and a plurality of secondary flow channels;
a valve device structured and arranged to open and close the secondary flow channels; and
the valve device comprising a plurality of separately controllable spool valves movably arranged on a base member and a plurality of valve members having different flow characteristics,
wherein one of the valve members is assigned to one of the secondary flow channels and another of the valve members is assigned to another of the secondary flow channels.

2. The shock absorber of claim 1, wherein the shock absorber is structured and arranged for use on a motor vehicle.

3. The shock absorber of claim 1, wherein the piston is in sealing engagement with the shock absorber cylinder.

4. The shock absorber of claim 1, wherein the one of the valve members is arranged to at least one of block and allow flow through one of the secondary flow channels and the other of the valve members is arranged to at least one of block and allow flow through another of the secondary flow channels.

5. The shock absorber of claim 1, wherein the one of the valve members is spaced apart from the other of the valve members.

6. The shock absorber of claim 1, wherein the one of the valve members and the other of the valve members comprise separate valve members.

7. The shock absorber of claim 1, wherein when the one of the valve members is positioned to allow fluid flow through at least one of the secondary flow channels and between the two chambers, the other of the valve members is positioned to prevent fluid flow through at least another of the secondary flow channels and between the two chambers.

8. The shock absorber of claim 1, wherein when the one of the valve members is positioned to allow fluid flow through at least one of the secondary flow channels and between the two chambers, the other of the valve members is positioned to allow fluid flow through at least another of the secondary flow channels and between the two chambers.

9. The shock absorber of claim 1, wherein each of the valve members comprises a single valve body.

10. The shock absorber of claim 1, wherein at least one of the valve members is an excess-pressure valve.

11. The shock absorber of claim 1, wherein each of the valve members is an excess-pressure valve.

12. The shock absorber of claim 1, wherein at least one of the valve members is arranged within the main flow channel.

13. The shock absorber of claim 1, wherein at least one of the valve members is arranged within the main flow channel, the one of the valve members is arranged within one of the secondary flow channels, and the other of the valve members is arranged within another of the secondary flow channels.

14. The shock absorber of claim 13, wherein each of the valve members has a different flow characteristic.

15. The shock absorber of claim 1, wherein the plurality of secondary flow channels comprise two secondary flow channels.

16. The shock absorber of claim 1, wherein the plurality of secondary flow channels comprise first, second and third secondary flow channels.

17. The shock absorber of claim 16, wherein the third secondary flow channel is arranged within the valve device.

18. The shock absorber of claim 16, wherein the third secondary flow channel is structured and arranged to allow fluid flow therethrough when the first and second flow channels allow fluid flow therethrough.

19. The shock absorber of claim 16, wherein the third secondary flow channel is structured and arranged to allow fluid flow therethrough when the spool valves are in an open position.

20. The shock absorber of claim 1, wherein one of the spool valves comprises an inner recess and wherein the base member comprises at least one recess.

21. The shock absorber of claim 20, wherein the one of the spool valves is movable between at least a first position, wherein the inner recess and the at least one recess of the base member are in fluid communication with each other, and a second position, wherein the inner recess and the at least one recess of the base member are not in fluid communication with each other.

22. The shock absorber of claim 21, wherein the inner recess comprises an inner circumferential recess.

23. The shock absorber of claim 22, wherein the valve device further comprises a through-opening structured and arranged to provide fluid communication between one of the two chambers and the inner circumferential recess.

24. The shock absorber of claim 1, wherein the valve device further comprises a through-opening structured and arranged to provide fluid communication between one of the two chambers and an inner circumferential recess of one of the spool valves.

25. The shock absorber of claim 1, wherein at least one of the secondary flow channels is free of valve members.

26. The shock absorber of claim 1, wherein the plurality of secondary flow channels comprise first, second and third secondary flow channels and wherein the plurality of the valve members comprises first, second, and third valve members.

27. A method of damping vibrations using the shock absorber of claim 1, wherein the method comprises:
allowing, at least during an expansion phase of the shock absorber, fluid to flow through the main flow channel when the spool valves are closed; and
allowing, at least during an expansion phase of the shock absorber, fluid to flow through at least one of the secondary flow channels when one of the spool valves are opened and another of the spool valves are closed.

28. A shock absorber having variable damping characteristics, the shock absorber comprising:
a shock absorber cylinder containing a damping medium;
a piston rod movably arranged within the shock absorber cylinder;
a piston coupled to the piston rod;
the piston being structured and arranged to divide a space inside the shock absorber cylinder into first and second chambers;
the first and second chambers being in fluid communication with each other via a main flow path and at least first and second secondary flow paths;
a valve device arranged between the piston and the piston rod;
the valve device comprising first and second separately controllable spool valves movably arranged on a base member and at least first and second valve members having different flow characteristics;
the first valve member being structured and arranged to allow and prevent fluid flow through the first secondary flow path; and
the second valve member being structured and arranged to allow and prevent fluid flow through the second secondary flow path.

29. The shock absorber of claim 28, wherein the shock absorber is structured and arranged for use on a motor vehicle.

30. The shock absorber of claim 28, wherein the piston is in sealing engagement with the shock absorber cylinder.

31. The shock absorber of claim 28, wherein the valve device is positionable such that the first valve member allows fluid flow through the first secondary flow path and between the first and second chambers, and the second valve member prevents fluid flow through the second secondary flow path and between the first and second chambers.

32. The shock absorber of claim 31, wherein the valve device is positionable such that the first and second valve members allow fluid flow through the first and second secondary flow paths and between the first and second chambers.

33. The shock absorber of claim 31, wherein the valve device is positionable such that the first and second valve members prevent fluid flow through the first and second secondary flow paths and between the first and second chambers.

34. The shock absorber of claim 28, wherein each of the first and second valve members comprises a single valve body.

35. The shock absorber of claim 28, wherein at least one of the first and second valve members is an excess-pressure valve.

36. The shock absorber of claim 28, further comprising a third valve member structured and arranged to allow and prevent fluid flow through the main flow path.

37. The shock absorber of claim 36, wherein each of the first, second and third valve members have different flow characteristics.

38. The shock absorber of claim 36, further comprising a third secondary flow path allowing fluid communication between the first and second chambers via the valve device.

39. The shock absorber of claim 38, wherein the third secondary flow path is structured and arranged to allow fluid flow therethrough when the first and second flow paths allow fluid flow therethrough.

40. The shock absorber of claim 38, wherein the third secondary flow path is structured and arranged to allow fluid flow therethrough when the first and second spool valves are in an open position.

41. The shock absorber of claim 28, wherein the first spool valve comprises an inner recess and wherein the base member comprises at least one recess.

42. The shock absorber of claim 41, wherein the first spool valve is movable between at least a first position, wherein the inner recess and the at least one recess of the base member are in fluid communication with each other, and a second position, wherein the inner recess and the at least one recess of the base member are not in fluid communication with each other.

43. The shock absorber of claim 41, wherein the inner recess comprises an inner circumferential recess.

44. The shock absorber of claim 43, wherein the valve device further comprises a through-opening structured and arranged to provide fluid communication between one of the two chambers and the inner circumferential recess.

45. The shock absorber of claim 28, wherein the valve device further comprises a through-opening structured and arranged to provide fluid communication between the one of the first and second chambers and an inner circumferential recess of one of the first and second spool valves.

46. The shock absorber of claim 28, further comprising a third secondary flow path which is free of valve members.

47. The shock absorber of claim 28, further comprising a third secondary flow path and a third valve member.

48. A method of damping vibrations using the shock absorber of claim 28, wherein the method comprises:
allowing, at least during an expansion phase of the shock absorber, fluid to flow through the main flow path when the first and second spool valves are closed;
allowing, at least during an expansion phase of the shock absorber, fluid to flow through the first secondary flow path when the first spool valve is opened and the second spool valve is closed; and
allowing, at least during an expansion phase of the shock absorber, fluid to flow through the second secondary flow path when the second spool valve is opened and the first spool valve is closed.

49. A shock absorber having variable damping characteristics, the shock absorber comprising:
a shock absorber cylinder containing a damping medium;
a piston rod movably arranged within the shock absorber cylinder;
a piston coupled to the piston rod and being in sealing engagement with the shock absorber cylinder;
the piston being structured and arranged to divide a space inside the shock absorber cylinder into first and second chambers;
the first and second chambers being in fluid communication with each other via a main flow path and at least first and second secondary flow paths;
the main flow path passing through an opening in the piston, wherein the opening is offset from a center axis of the piston rod;
the first and second flow paths passing through a different opening which extends through the piston;
a valve device having a larger diameter tubular end coupled to the piston and a smaller diameter end coupled to the piston rod;
the valve device comprising first and second separately controllable spool valves movably arranged on a base member and at least first and second valve members having different flow characteristics;
a first spring biasing the first spool valve towards a closed position and a second spring biasing the second spool valve towards a closed position;
the first valve member being structured and arranged to allow and prevent fluid flow through the first secondary flow path; and
the second valve member being structured and arranged to allow and prevent fluid flow through the second secondary flow path.

50. The shock absorber of claim 49, wherein the valve device having one end which is connected to the piston and another end which is threadably connected to the piston rod.
